(19) United States
(12) Patent Application Publication
(10) Pub. No.: US 2026/0062890 A1
(43) Pub. Date: Mar. 5, 2026

(54) HETEROGENEOUS CONSTRUCTION EQUIPMENT REMOTE CONTROL SYSTEM

(71) Applicant: DASAN Networks, Inc., Seongnam-si (KR)

(72) Inventor: Young Han KIM, Seongnam- si (KR)

(73) Assignee: DASAN Networks, Inc., Seongnam-si (KR)

(21) Appl. No.: 18/930,982

(22) Filed: Oct. 29, 2024

(30) Foreign Application Priority Data
Aug. 30, 2024 (KR) 10-2024-0117429

(51) Int. Cl. E02F 9/20; H04L 12/46; H04L 69/16

(52) U.S. Cl. CPC E02F 9/205; H04L 12/4683; H04L 69/16

(57) ABSTRACT

A construction equipment remote control system of the present invention is a system capable of remotely controlling heterogeneous construction equipment using a single remote control device, and is a remote control system capable of automatically setting a remote control device to match construction equipment to be controlled remotely using provisioning information of construction equipment registered when the remote control device selects the construction equipment to be controlled remotely.

### CROSS-REFERENCE TO RELATED APPLICATION(S)

This application claims priority from Korean Patent Application No. 10-2024-0117429, filed on Aug. 30, 2024, in the Korean Intellectual Property Office, the disclosure of which is incorporated herein by reference in its entirety.

### BACKGROUND

### 1. Field

The present invention relates to a technology for remotely controlling construction equipment located at a remote location, and more particularly, to a system for remotely controlling heterogeneous construction equipment using the same remote station.

### 2. Description of Related Art

In construction equipment such as excavators and bulldozers, workers directly ride in the driver's seats and operate manipulation devices to perform various tasks. Due to the operating characteristics of the construction equipment, in many cases, work locations such as construction sites and disaster sites, environments, etc. are poor, and thus situations in which it is dangerous for workers to ride and operate the construction equipment often occur.

A system that can operate construction equipment at a remote location is required. Recently, telematics devices have been installed in construction equipment including large excavators, and thus many attempts are being made to remotely control the construction equipment using these telematics devices.

Construction equipment has different operating methods depending on its characteristics. For example, there are construction equipment with a steering wheel and construction equipment without a steering wheel. Further even for the same type of construction equipment, there is a problem in that specifications differ depending on the manufacturer or model. For example, baud rates of controller area network (CAN) buses inside construction equipment vehicles and CAN messages for each control may be different.

Therefore, there is a problem in that various dedicated remote stations should be provided to match corresponding construction equipment to be controlled remotely, or that settings of the remote stations should be changed every time to match the corresponding construction equipment.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a system that is capable of selecting one from among heterogeneous construction equipment at remote locations and remotely controlling the selected construction equipment using a remote control device.

In one general aspect, a construction equipment remote control system includes one or more remote control devices, one or more pieces of construction equipment, one or more virtual private network relay servers, and a remote control server.

The remote control server may include a device registration unit that registers provisioning information transmitted by the construction equipment, remote control device, and virtual private network relay server that initially access the remote control server when requesting provisioning.

The construction equipment may include a communication terminal that establishes a virtual private network connection with the remote control device through the virtual private network relay server to communicate with the remote control device, and a device registration unit that transmits the provisioning information of the construction equipment to the remote control server and registers the provisioning information.

The virtual private network relay server may control the virtual private network connection between the construction equipment and the remote control device and transmit provisioning information of the virtual private network relay server to the remote control server and register the provisioning information.

The remote control device may include an instrument panel unit that provides a construction equipment selection interface through which construction equipment to be controlled remotely is allowed to be selected, a communication unit including a virtual private network server that establishes a virtual private network connection with the construction equipment through the virtual private network relay server, and a control unit including a device registration unit that transmits control device provisioning information to the remote control server and registers the control device provisioning information, an equipment setting unit that sets a device on the basis of the provisioning information of the construction equipment selected through the instrument panel unit, and a manipulation unit that generates a control signal message for operating the construction equipment remotely, wherein the manipulation unit generates a control signal message suitable for the construction equipment to be controlled remotely according to the setting of the equipment setting unit.

According to one aspect of the present invention, the instrument panel unit of the remote control device may provide the construction equipment selection interface through which a logged-in driver is allowed to select only construction equipment that is able to be driven with his/her registered license.

According to one aspect of the present invention, the remote control server may further include a construction equipment registration unit that receives and registers information on a model of the construction equipment to be controlled remotely.

According to one aspect of the present invention, the remote control server may further include a device management unit that receives and manages status from the construction equipment, remote control device, and virtual private network relay server for which the provisioning information is registered, and in this case, the construction equipment, remote control device, and virtual private network relay server for which the provisioning information is registered may report their status to the remote control server at set intervals.

According to one aspect of the present invention, the control unit of the remote control device may further include a signal conversion unit that encapsulates the control signal message generated by the manipulation unit to generate an Internet Protocol (IP) message.

According to one aspect of the present invention, the remote control server may transmit a virtual private network connection command to the remote control device, the virtual private network relay server, and the construction equipment, and the virtual private network connection may be established between the construction equipment and the remote control device using User Datagram Protocol (UDP) hole punching using information on a public IP address of the other party received from the virtual private network relay server.

According to another aspect of the present invention, the remote control server may transmit a virtual private network connection command to the remote control device, the virtual private network relay server, and the construction equipment, a first virtual private network connection may be established between the virtual private network relay server and the remote control device, a second virtual private network connection may be established between the virtual private network relay server and the construction equipment, and the virtual private network relay server may relay a packet between the first virtual private network and the second virtual private network.

According to one aspect of the present invention, the device management unit of the remote control server may select and determine the virtual private network relay server on the basis of a location of the construction equipment selected for remote control through the instrument panel unit of the remote control device or on the basis of set system policy.

### BRIEF DESCRIPTION OF THE DRAWINGS

FIG. 1 is a diagram illustrating a configuration of a construction equipment remote control system according to one aspect of the present invention.

FIG. 2 is a detailed block diagram of the construction equipment remote control system according to one aspect of the present invention.

FIG. 3 is a diagram conceptually illustrating an example in which a virtual private network connection is directly established between a remote control device and construction equipment.

FIG. 4 is a diagram conceptually illustrating an example in which a virtual private network connection via a virtual private network relay server is established between a remote control device and construction equipment.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It is understood that components of each embodiment are possible in various combinations within one embodiment unless otherwise stated or inconsistent with each other. Each block in a block diagram may in some cases represent a physical part, but in other cases may be a logical representation of a portion of a function of one physical part or a function that spans a plurality of physical parts. In some cases, a block or the entity of a portion thereof may be a set of program instructions. These blocks may be implemented in whole or in part as hardware, software, or a combination thereof.

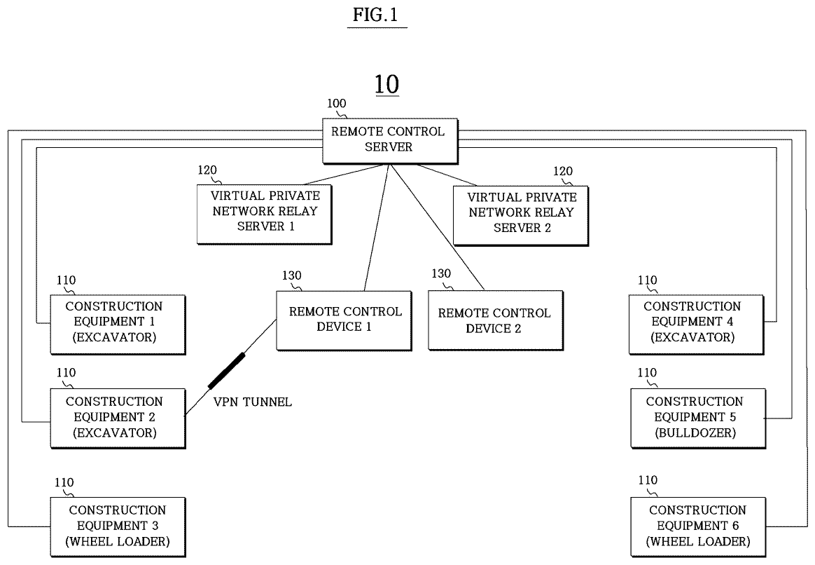

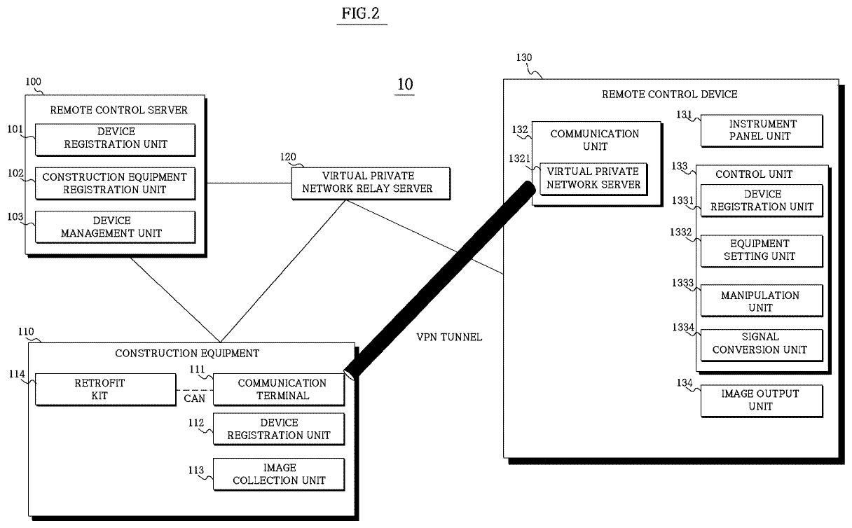

FIG. 1 is a diagram illustrating a configuration of a construction equipment remote control system according to one aspect of the present invention, and FIG. 2 is a detailed block diagram of the construction equipment remote control system according to one aspect of the present invention. A construction equipment remote control system 10 according to one aspect of the present invention includes one or more remote control devices 130, one or more pieces of construction equipment 110, one or more virtual private network (VPN) relay servers 120, and a remote control server 100.

The remote control device 130 is referred to as a remote control station or station controller and is a device that controls, i.e., operates, the construction equipment 110 using a manipulation device such as a steering wheel, a joystick, or the like at a remote location while watching an image, and the construction equipment remote control system 10 of the present invention may include at least one remote control device 130 capable of remotely controlling the construction equipment 110.

The construction equipment 110 is referred to as heavy equipment, includes equipment such as a bulldozer, an excavator, and a wheel loader, etc., and includes an additional configuration (e.g., a telematics gateway unit (TGU), a retrofit kit, etc.) that can be controlled remotely.

In the construction equipment remote control system 10 of the present invention, rather than the construction equipment 110 that can be remotely controlled being determined for each remote control device 130, one remote control device 130 may control various construction equipment, in particular, heterogeneous construction equipment.

The VPN relay server 120 is a server that sets a VPN so that the construction equipment 110 and the remote control device 130 located at separate locations can communicate with each other, or that relays data exchange between set VPNs.

The remote control server 100 may include a device registration unit 101.

The remote control server 100 is a server that monitors, resisters, and manages other components constituting the construction equipment remote control system 10. In particular, the remote control server 100 resisters and manages the construction equipment 110, the remote control device 130, and the VPN relay server 120 and provides information required by each device. For example, the remote control server 100 may provide a list of construction equipment registered in the remote control device 130.

The device registration unit 101 may be implemented as a set of computer program instructions that runs on at least some of its functions or on a processor of the remote control server 100. The device registration unit 101 registers provisioning information transmitted by the construction equipment 110, the remote control device 130, and the VPN relay server 120 that initially access the remote control server 100 when requesting provisioning. The device registration unit 101 registers the provisioning information and models the construction equipment 110, the remote control device 130, and the VPN relay server 120. When the remote control device 130 sets a device to match the construction equipment 110 to be controlled remotely, the remote control device 130 may conveniently set the corresponding device using the provisioning information, that is, model information.

The remote control server 100 models, registers, and manages each of the construction equipment 110, the remote control device 130, and the VPN relay server 120. Since the construction equipment 110, the remote control device 130, and the VPN relay server 120 generally have different specifications for each device, the remote control server 100 models the construction equipment 110, the remote control device 130, and the VPN relay server 120 using predetermined specification information (e.g., a controller area network (CAN) baud rate of the construction equipment, a CAN database connection (DBC) of the construction equipment, whether the construction equipment has a steering wheel, whether the remote control device 130 has a steering wheel, a public Internet Protocol (IP) address of the VPN relay server 120, etc.). There is no limitation on a type of specification information required to model each device, and the specification information needs to be structured to include the characteristics of the device and information required for remote control.

The device registration unit 101 processes provisioning requests transmitted by the construction equipment 110, the remote control device 130, and the VPN relay server 120 that initially access the remote control server 100 in order to register themselves, and registers the devices. The devices that have transmitted the requests include pre-defined provisioning information in the corresponding request, and transmit the request to the remote control server 100 so that the device registration unit 101 can register and model the provisioning information on each device.

According to one aspect of the present invention, the remote control server 100 may further include a construction equipment registration unit 102 that receives and registers information on a model of the construction equipment to be controlled remotely.

The construction equipment registration unit 102 receives information related to the model of the construction equipment to be controlled remotely from an administrator and registers the model of the construction equipment. The construction equipment registration unit 102 may be implemented as a set of computer program instructions that runs on at least some of its functions or on the processor of the remote control server 100, and provides a user interface through which the administrator can input the information on the model.

A device management unit 103 models the construction equipment 110 by mapping the information on the model of the construction equipment to the provisioning information on the construction equipment 110 when the provisioning information on the construction equipment 110 is registered.

The remote control server 100 may use the information modeled for each piece of construction equipment 110 to automatically set the remote control device 130 to match the construction equipment 110 to be controlled remotely.

According to one aspect of the present invention, the remote control server 100 may further include the device management unit 103 that receives and manages status from the construction equipment 110, remote control device 130, and VPN relay server 120 for which the provisioning information is registered.

The device management unit 103 may be implemented as a set of computer program instructions that runs on at least some of its functions or on the processor of the remote control server 100. The device management unit 103 may periodically receive and manage the status of the registered construction equipment 110, remote control device 130, and VPN relay server 120. The status checked by the device management unit 103 may include whether the device is currently being remotely controlled and whether the device is capable of network communication. Further, depending on a type of network address translation (NAT) used in a network to which the registered construction equipment 110 or remote control device 130 belongs, it is necessary to periodically exchange messages to ensure that the binding of a public IP address and a private IP address is not deleted from the corresponding NAT, and thus the device management unit 103 may manage the corresponding binding to be maintained by repeatedly transmitting messages to connection information, i.e., public IP addresses, of the registered devices.

In this case, the construction equipment 110, remote control device 130, and VPN relay server 120 for which the provisioning information is registered may report their current status to the remote control server 100 at set intervals.

The construction equipment 110 may include a communication terminal 111 and a device registration unit 112.

The communication terminal 111 is a TGU that can be connected to the Internet via a commercial communication network, such as a mobile communication network or Wi-Fi. The communication terminal 111 receives a control signal for operating the construction equipment 110 from the remote control device 130.

The communication terminal 111, that is, the TGU, is a type of telematics device. The TGU is connected to a wireless communication network. Examples of the wireless communication network include a 3^{rd}-generation (3G) mobile communication network, a 4^{th}-generation (4G) Long-Term Evolution (LTE) mobile communication network, a 5^{th}-generation (5G) mobile communication network, etc. The communication terminal 111 is connected to a wireless communication network and provides an Internet connection service to the construction equipment 110. Further, the communication terminal 111 is connected to an internal network of the construction equipment 110 to communicate with various electronic control units (ECUs) of the construction equipment 110. Alternatively, the communication terminal 111 may communicate with a retrofit kit 114 of the construction equipment 110 attached for remote control in addition to communicating with the ECU.

The internal network of the construction equipment 110 may be any one of a CAN, Ethernet, FlexRay, a local interconnect network (LIN), and the like, but one or more of them may be used. For example, the internal network of the construction equipment 110 may communicate with the retrofit kit 114 using a CAN bus and with the ECU using Ethernet.

The communication terminal 111 connected to the Internet via a wireless communication network receives a construction equipment control signal message that is transmitted by the remote control device 130 at a remote location via a VPN, transmits the received construction equipment control signal message to a specific ECU or the retrofit kit 114 via the internal network of the construction equipment 110, and allows the construction equipment 110 to be controlled remotely.

The device registration unit 112 transmits provisioning information of the construction equipment to the remote control server 100 and registers the provisioning information of the construction equipment. The device registration unit 112 transmits a provisioning request to the remote control server 100 and transmits provisioning information of a corresponding device that is pre-defined.

The construction equipment 110 may further include an image collection unit 113. The image collection unit 113 generates and transmits image information of a work site using one or more cameras installed in the construction equipment 110. One or more cameras are installed at predetermined locations of the construction equipment 110 to capture an image of the work site, and the image collection unit 113 generates the image information from the captured image. The image collection unit 113 collects images obtained by capturing the surroundings of the construction equipment in order to provide images that are similar to those when a remote worker is riding and operating the construction equipment 110 on site. The image collection unit 113 transmits the captured images to the communication terminal 111 via the internal network (e.g., Ethernet) of the construction equipment 110 and transmits the captured images to the remote control device 130 at a remote location through the communication terminal 111.

A private IP address is generally assigned to the communication terminal 111 rather than a public IP address from a communication network operator. Therefore, even when the remote control device 130 obtains the IP address assigned to the construction equipment 110, in particular, the communication terminal 111, a problem that a message cannot be directly transmitted to the corresponding communication terminal 111 occurs. That is, a problem that peer-to-peer (P2P) communication between the remote control device 130 and the communication terminal 111 is impossible may occur.

In order to solve the above problems, a VPN connection is established between the remote control device 130 and the communication terminal 111, that is, tunneling is used. In this case, a 3-layer tunneling protocol such as IP Security Protocol (IPSec) may be used as a tunneling protocol. However, the present invention is limited thereto, and the VPN connection may be established between the construction equipment 110 and the remote control device 130 using a secure sockets layer (SSL) VPN tunneling method.

The VPN connection is established between the communication terminal 111 and the remote control device 130, and then the communication terminal 111 receives a control signal message for operating the construction equipment 110 from the remote control device 130 through the established VPN connection. Further, the communication terminal 111 receives the image information generated by the image collection unit 113 via the internal network and transmits the image information to the remote control device 130 through the VPN connection, that is, a VPN tunnel.

The VPN relay server 120 is involved in the VPN connection between the communication terminal 111 and the remote control device 130. That is, the VPN relay server 120 controls the VPN connection between the construction equipment 110 and the remote control device 130.

The remote control server 100 requests the initiation of the VPN connection from each of the construction equipment 110 and the remote control device 130 that require the VPN connection. In this case, the remote control server 100 transmits an access address of the VPN relay server 120, that is, a public IP address, to the construction equipment 110 and the remote control device 130 so that a VPN can be formed between the construction equipment 110 and the remote control device 130 through the VPN relay server 120.

The VPN relay server 120 is a computing device that is connected to a network in which the remote control device 130 and the communication terminal 111 of the construction equipment 110 are managed so that a VPN connection can be established between the remote control device 130 and the communication terminal 111 of the construction equipment 110, and the VPN relay server 120 includes a processor, a memory, a display, and various types of input/output devices. The VPN relay server 120 has a public IP address so that the remote control device 130 and the communication terminal 111 of the construction equipment 110 can be directly connected to each other.

The VPN relay server 120 obtains an NAT-converted public IP address (including a port number) mapped to the private IP address of the communication terminal 111 of the construction equipment 110 using a packet transmitted when the communication terminal 111 of the construction equipment 110 requests a VPN connection, and obtains an NAT-converted public IP address (including a port number) mapped to a private IP address of the remote control device 130 using a packet transmitted when the remote control device 130 requests a VPN connection. When the VPN relay server 120 responds to the request, the VPN relay server 120 informs the communication terminal 111 of the construction equipment 110 of the NAT-converted public IP address of the remote control device 130 and informs the remote control device 130 of the NAT-converted public IP address of the communication terminal 111 of the construction equipment 110 to allow a VPN to be formed between the communication terminal 111 of the construction equipment 110 and the remote control device 130.

The VPN relay server 120 transmits server provisioning information including its own accessible address to the remote control server 100 and registers the server provisioning information.

The remote control device 130 includes an instrument panel unit 131, a communication unit 132, and a control unit 133.

The instrument panel unit 131 displays various pieces of information related to operation received from the remotely controlled construction equipment 110 and provides a construction equipment selection interface through which the construction equipment 110 to be controlled remotely can be selected. The instrument panel unit 131 obtains the list of construction equipment registered in the remote control server 100 from the remote control server 100 and displays the list of construction equipment through the construction equipment selection interface so that a driver can select the construction equipment 110 to be controlled remotely.

According to one aspect of the present invention, the instrument panel unit 131 of the remote control device 130 may provide a construction equipment selection interface so that a logged-in driver can select only the construction equipment 110 that can be driven with a registered license.

The instrument panel unit 131 provides a user interface through which the driver who will remotely control the construction equipment 110 using the remote control device 130 can log in, transmits driver identification information input through the corresponding interface to the remote control server 100 that has the driver information, and then completes the login after receiving authentication. In this case, the instrument panel unit 131 receives license information of the driver from the remote control server 100 and allows only the construction equipment 110 that the corresponding driver can drive to be displayed on the construction equipment selection interface on the basis of the license information. For example, when the license of the driver is for an excavator, only the construction equipment 110 whose type is an excavator among the list of the construction equipment received from the remote control server 100 may be displayed, or the list of the construction equipment whose type is an excavator may be received from the remote control server 100 and displayed. Therefore, the driver may only select the construction equipment 110 that he or she can drive with the license he or she has.

The communication unit 132 is a device that provides an Internet connection through a wired or wireless communication network. The communication unit 132 may be composed of a network switch and a server capable of forming a VPN.

A VPN server 1321 included in the communication unit 132 establishes a VPN connection with the construction equipment 110 through the VPN relay server 120.

The control unit 133 includes a device registration unit 1331, an equipment setting unit 1332, and a manipulation unit 1333.

The device registration unit 1331 transmits a provisioning request to the remote control server 100 and transmits control device provisioning information including information on the specifications of the remote control device 130 or device options (e.g., presence or absence of a steering wheel and the like) to register the control device provisioning information in the remote control server 100.

The equipment setting unit 1332 sets the device on the basis of the provisioning information of the construction equipment 110 selected through the instrument panel unit 131. When the driver selects the construction equipment 110 remotely controlled through an instrument panel to obtain the provisioning information of the corresponding construction equipment 110 from the remote control server 100, the equipment setting unit 1332 sets the remote control device 130 according to the received provisioning information of the construction equipment 110. For example, the remote control device 130 is set based on the CAN baud rate, CAN DBC (dbc file), etc. included in the provisioning information of the construction equipment 110, and the control signal message generated by remote operation causes a signal suitable for the corresponding construction equipment 110 to be generated.

The manipulation unit 1333 includes a manipulation device (e.g., a steering wheel, a joystick, etc.) that remotely manipulates the construction equipment 110, and when the manipulation device is manipulated, allows a control signal message for remotely manipulating the construction equipment 110 to be generated, and a control signal message suitable for the construction equipment 110 to be controlled remotely to be generated according to the settings of the equipment setting unit 1332. For example, when the CAN baud rate of the selected construction equipment 110 is 250 K, the manipulation unit 1333 generates a control signal with a CAN baud rate of 250 K.

The remote control device 130 may include an image output unit 134.

The image output unit 134 includes one or more displays and displays the image information of the work site received through the VPN connection, that is, the VPN tunnel, formed between the remote control device 130 and the construction equipment 110 on the display. The image information received at this time may be a plurality of images captured by a plurality of cameras, and the plurality of captured images may be integrated into a single image and then output through the display or the images may each be output through a different display. For example, when an image captured in a forward direction of the construction equipment 110 and images captured in left and right directions of the construction equipment 110 are received, the forward, left, and right direction images may be output separately through three displays. A worker who wants to remotely control the construction equipment 110 manipulates the manipulation unit 1333 while watching the images output from the image output unit 134.

According to one aspect of the present invention, the control unit 133 of the remote control device 130 may further include a signal conversion unit 1334.

The signal conversion unit 1334 may encapsulate the control signal message generated by the manipulation unit 1333 to generate an IP message. A control signal message transmitted through the VPN between the remote control device 130 and the construction equipment 110 may be an IP packet, and the control signal generated by the manipulation unit 1333 may be, for example, a CAN control signal in the internal network of the vehicle, and in particular, may be a CAN control signal suitable for the construction equipment 110 selected for remote control. The signal conversion unit 1334 performs a function of generating an IP packet encapsulated with an internal network control signal message of the vehicle as a payload, that is, a CAN-to-Ethernet conversion function.

Since the remote control device 130 and the construction equipment 110 are each located in a private network, it is impossible to access the remote control device 130 or the construction equipment 110 from outside the corresponding private network, and thus the present invention solves this problem by connecting a VPN between two devices.

According to one aspect of the present invention, it is possible to attempt to establish a VPN connection between the remote control device 130 and the construction equipment 110 directly with the help of a VPN relay. The VPN connection may be established between the construction equipment 110 and the remote control device 130 using User Datagram Protocol (UDP) hole punching using the information on the public IP address of the other party that is received from the VPN relay server 120.

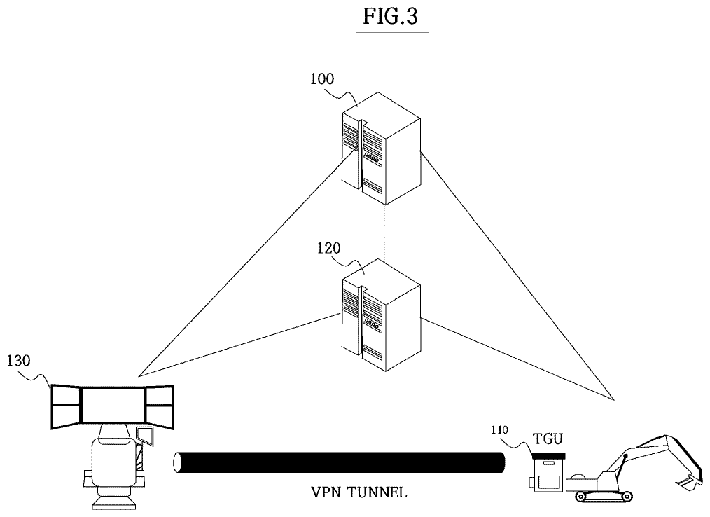

FIG. 3 is a diagram conceptually illustrating an example in which a VPN connection is directly established between the remote control device 130 and the construction equipment 110. In the example illustrated in FIG. 3, a VPN tunnel is established between the remote control device 130 and the construction equipment 110 using a UDP hole punching method.

To roughly describe the VPN connection process using UDP hole punching, first, the remote control server 100 transmits a VPN connection command to the remote control device 130, the VPN relay server 120, and the construction equipment 110 to directly form a VPN between the remote control device 130 and the construction equipment 110. The remote control server 100 informs the remote control device 130 and the construction equipment 110 of an address of the VPN relay server 120 from which the remote control device 130 and the construction equipment 110 can obtain an accessible public IP address (public IP address and port number) of the other party, and informs the VPN relay server 120 of information (e.g., a public IP address) of the remote control device 130 and the construction equipment 110 that will participate in a VPN connection session.

The remote control device 130 and the construction equipment 110 that receive the VPN connection command from the remote control server 100 may transmit their private IP addresses (private IP address and port number) to the VPN relay server 120 and register the private IP addresses. In this registration process, the VPN relay server 120 may communicate with the remote control device 130 and the construction equipment 110 through the NAT-converted public IP address of each device identified from packets transmitted by the remote control device 130 and the construction equipment 110 for registration. In this case, the VPN relay server 120 may transmit the public IP addresses of the remote control device 130 and the construction equipment 110 to be connected to the VPN to each other. However, the procedure in which the VPN relay server 120 transmits the public IP addresses of the remote control device 130 and the construction equipment 110 to each other may be omitted, and in this case, the remote control server 100 transmits the public IP addresses of the remote control device 130 and the construction equipment 110 to each other when transmitting the VPN connection command.

After the construction equipment 110 is registered in the VPN relay server 120, the construction equipment 110 requests a VPN connection request including the public IP address of the remote control device 130 from the VPN relay server 120, obtains the public IP address (NAT-converted public IP address and port number) of the remote control device 130 and the private IP address information (private IP address and port number) from the VPN relay server 120, and then transmits a UDP packet to connect P2P communication with the remote control device 130. In this case, an entry that can communicate with the remote control device 130 is registered (UDP hole punching) in an internal table (binding table and filtering table) of the NAT on the construction equipment side using the UDP packet transmitted from the construction equipment side.

The VPN relay server 120 transmits the VPN connection request requested by the construction equipment 110 to the remote control device 130. In this case, the VPN relay server 120 includes the public IP address (NAT-converted public IP address and port number) of the construction equipment 110 and the private IP address information (private IP address and port number) in the corresponding VPN connection request and transmits the corresponding VPN connection request to the remote control device 130.

The remote control device 130 that receives the VPN connection request from the VPN relay server 120 transmits a UDP packet to enable P2P communication with the public IP address of the construction equipment 110 included in the corresponding request. In this case, an entry that can communicate with the construction equipment 110 is registered (UDP hole punching) in the internal table (binding table and filtering table) of the NAT on the remote control device 130 side using the UDP packet transmitted from the remote control device 130 side.

Thereafter, the construction equipment 110 and the remote control device 130 perform a procedure to establish a tunnel using each other's NAT-converted public addresses.

Depending on an NAT device used in a private network where the remote control device 130 and the construction equipment 110 are located, it may not be possible to establish a VPN connection using a UDP hole punching method. In this case, it is difficult to establish a direct VPN connection between the remote control device 130 and the construction equipment 110, but the above problem may be solved by forming the VPN between two devices using the VPN relay server 120 in a VPN relay method.

When the VPN relay server 120 cannot establish a direct VPN connection between the remote control device 130 and the construction equipment 110, the VPN relay server 120 may form a VPN between the VPN relay server 120 and the remote control device 130 and a VPN between the VPN relay server 120 and the construction equipment 110, and then the VPN relay server 120 may bridge the two VPNs to provide a relay service.

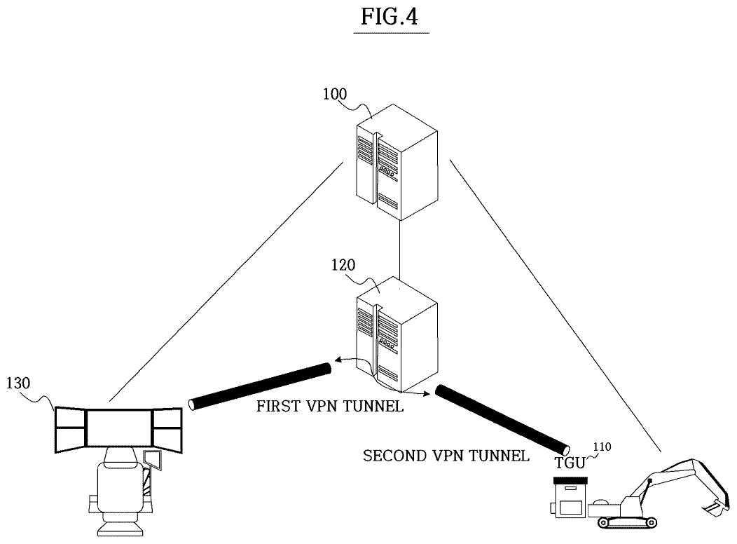

FIG. 4 is a diagram conceptually illustrating an example in which a VPN connection via the VPN relay server is established between the remote control device and the construction equipment.

According to another aspect of the present invention, the remote control server 100 may transmit a VPN connection command to the remote control device 130, the VPN relay server 120, and the construction equipment 110, a first VPN connection may be established between the VPN relay server 120 and the remote control device 130, a second VPN connection may be established between the VPN relay server 120 and the construction equipment 110, and the VPN relay server 120 may relay packets between the first VPN and the second VPN.

To roughly describe the VPN connection process using a relay service of the VPN relay server 120, to form the VPN between the remote control device 130 and the construction equipment 110, first, the remote control server 100 transmits a first VPN connection command to the construction equipment 110 and the VPN relay server 120 so that the first VPN connection is established between the VPN relay server 120 and the construction equipment 110. Further, the remote control server 100 transmits a second VPN connection command to the remote control device 130 and the VPN relay server 120 so that the second VPN connection is established between the VPN relay server 120 and the remote control device 130. Thereafter, the remote control server 100 may transmit a command to relay the first VPN and the second VPN to the VPN relay server 120 so that the VPN relay server 120 relays packets between the first VPN and the second VPN. Therefore, the VPN connection may be established between the remote control device 130 and the construction equipment 110 via the VPN relay server 120. The VPN relay server 120 transmits a packet from the remote control device 130 toward the construction equipment 110 through the second VPN to the first VPN so that the corresponding packet is transmitted to the construction equipment 110, and transmits a packet from the construction equipment 110 toward the remote control device 130 through the first VPN to the second VPN so that the corresponding packet is transmitted to the remote control device 130.

There may be a plurality of VPN relay servers 120. For example, the VPN relay servers 120 may divide regions to be responsible for, and may allow the VPN relay server 120 in charge of the corresponding region to be involved in the VPN connection when remotely controlling the construction equipment 110 in a specific region. Alternatively, a specific VPN relay server 120 may be assigned for the VPN connection in order to distribute traffic according to system policy.

According to one aspect of the present invention, the device management unit 103 of the remote control server 100 may select and determine the VPN relay server 120 on the basis of the location of the construction equipment 110 that is selected for remote control through the instrument panel unit 131 of the remote control device 130 or on the basis of set system policy.

In the case in which a VPN relay server 120 in charge is determined for each region, the device management unit 103 of the remote control server 100 may determine a VPN relay server 120 in charge of a region where the construction equipment 110 selected by the driver through the instrument panel unit 131 of the remote control device 130 is located, and inform the construction equipment 110 and the remote control device 130 of the determined VPN relay server 120. Alternatively, when the driver selects the construction equipment 110 through the instrument panel unit 131 of the remote control device 130, the device management unit 103 of the remote control server 100 may select the VPN relay server 120 according to system policy (e.g., traffic distribution) and then inform the construction equipment 110 and the remote control device 130 of the selected VPN relay server 120.

According to the present invention, it is possible to select one from among various types of construction equipment located at remote locations and remotely control the selected construction equipment using a remote control device.

While exemplary embodiments of the present invention have been described with reference to the accompanying drawing, the present invention is not limited to the exemplary embodiments. It should be interpreted that various modifications that can be apparently made by those skilled in the art are included in the scope of the present invention. The appended claims are intended to cover the modifications.

What is claimed is:

1. A heterogeneous construction equipment remote control system, which is a construction equipment remote control system comprising one or more remote control devices, one or more pieces of construction equipment, one or more virtual private network relay servers, and a remote control server,
wherein the remote control server includes a device registration unit that registers provisioning information transmitted by the construction equipment, remote control device, and virtual private network relay server that initially access the remote control server when requesting provisioning,
the construction equipment includes a communication terminal that establishes a virtual private network connection with the remote control device through the virtual private network relay server to communicate with the remote control device, and a device registration unit that transmits the provisioning information of the construction equipment to the remote control server and registers the provisioning information,
the virtual private network relay server controls the virtual private network connection between the construction equipment and the remote control device and transmits the provisioning information of the virtual private network relay server to the remote control server and registers the provisioning information, and
the remote control device includes an instrument panel unit that provides a construction equipment selection interface through which construction equipment to be controlled remotely is allowed to be selected, a communication unit including a virtual private network server that establishes a virtual private network connection with the construction equipment through the virtual private network relay server, and a control unit including a device registration unit that transmits control device provisioning information to the remote control server and registers the control device provisioning information, an equipment setting unit that sets a device on the basis of the provisioning information of the construction equipment selected through the instrument panel unit, and a manipulation unit that generates a control signal message for operating the construction equipment remotely, wherein the manipulation unit generates a control signal message suitable for the construction equipment to be controlled remotely according to the setting of the equipment setting unit.

2. The construction equipment remote control system of claim 1, wherein the instrument panel unit provides the construction equipment selection interface through which a logged-in driver is allowed to select only construction equipment that is able to be driven with his/her registered license.

3. The construction equipment remote control system of claim 1, wherein the remote control server further includes a construction equipment registration unit that receives and registers information on a model of the construction equipment to be controlled remotely.

4. The construction equipment remote control system of claim 1, wherein the remote control server further includes a device management unit that receives and manages status from the construction equipment, remote control device, and virtual private network relay server for which the provisioning information is registered, and the construction equipment, remote control device, and virtual private network relay server for which the provisioning information is registered report their status to the remote control server at set intervals.

5. The construction equipment remote control system of claim 1, wherein the control unit further includes a signal conversion unit that encapsulates the control signal message generated by the manipulation unit to generate an Internet Protocol (IP) message.

6. The construction equipment remote control system of claim 1, wherein the remote control server transmits a virtual private network connection command to the remote control device, the virtual private network relay server, and the construction equipment, and
the virtual private network connection is established between the construction equipment and the remote control device using User Datagram Protocol (UDP) hole punching using information on a public IP address of the other party received from the virtual private network relay server.

7. The construction equipment remote control system of claim 1, wherein the remote control server transmits a virtual private network connection command to the remote control device, the virtual private network relay server, and the construction equipment,
a first virtual private network connection is established between the virtual private network relay server and the remote control device,
a second virtual private network connection is established between the virtual private network relay server and the construction equipment, and
the virtual private network relay server relays a packet between the first virtual private network and the second virtual private network.

8. The construction equipment remote control system of claim 1, wherein the device management unit of the remote control server selects and determines the virtual private network relay server on the basis of a location of the construction equipment selected for remote control through the instrument panel unit of the remote control device or on the basis of set system policy.
